(19) United States
(12) Patent Application Publication
(10) Pub. No.: US 2014/0049936 A1
(43) Pub. Date: Feb. 20, 2014

(54) ELECTRICAL DISCONNECT APPARATUS WITH FUSE

(71) Applicants: MARK ANDRE FAULKNER, Greenwood, SC (US); Jerry Sluder Wang, Arden, NC (US); Mark Terence Teaken, Greenwood, SC (US)

(72) Inventors: MARK ANDRE FAULKNER, Greenwood, SC (US); Jerry Sluder Wang, Arden, NC (US); Mark Terence Teaken, Greenwood, SC (US)

(21) Appl. No.: 13/584,960

(22) Filed: Aug. 14, 2012

(51) Int. Cl. H01H 85/20

(52) U.S. Cl. 361/833

(57) ABSTRACT

An electrical disconnect apparatus includes a housing having a first conductor configured to electrically connect to a first external circuit and a second conductor configured to electrically connect to a second external circuit; and a connection device having an elongated portion structured to be inserted into and removed from the housing. The elongated portion of the connection device includes a fuse having a first conductive end portion and a second conductive end portion electrically connected by a fusible element. The fuse electrically connects the first conductor to the second conductor when the elongated portion of the connection device is inserted into the housing and electrically disconnects the first conductor from the second conductor when the elongated portion of the connection device is removed from the housing.

### CROSS-REFERENCE TO RELATED APPLICATION

This application is related to commonly assigned, copending U.S. patent application Ser. No. 13/427,005, filed Mar. 22, 2012, entitled “ELECTRICAL DISCONNECT APPARATUS”.

### BACKGROUND

1. Field

The disclosed concept pertains generally to power distribution equipment and, more particularly, to electrical disconnect apparatus.

2. Background Information

Two primary objectives of the electric utility industry in the delivery of electrical power are safety and reliability. Since the late 1920s, AC secondary network systems have been used in certain locations such as downtown business districts and commercial areas in order to provide a high degree of service continuity. In such an AC secondary network system, a plurality of secondary mains surround the area being served, such as a city block, and are connected with a set of bus bars to form a secondary network grid at low voltage to which the customer loads are connected.

Electrical power is supplied to the secondary network by a plurality of medium voltage distribution lines. Each medium voltage distribution line delivers power to the network through network transformers. The transformers reduce the medium voltage from the distribution lines to a low voltage suitable for distribution to the customers.

In such secondary network systems, a failure of any one distribution line will not result in an interruption of service to the customers since electrical power will be supplied to the customers over the remaining distribution lines. When a failure or fault occurs in a medium voltage distribution line or in one of its associated network transformers, the station end of the distribution line, that is, the end of the distribution line closest to the generating station, is disconnected from the system by opening a feeder circuit breaker. In addition, it is necessary that all of the network transformers on the failed distribution line be disconnected from the secondary network by some type of protective device to prevent power from the secondary network from being fed back through the network transformers to the fault. The protective device that has been used for such purpose is the network protector.

The network protector comprises a specially designed circuit breaker with a closing and opening mechanism that is controlled by a relay. When the network protector is closed, the relay operates to trip the network protector upon a reversal of power flow. The relay acts to close the network protector when, and only when, the proper voltage conditions exist across the network protector.

Network protectors typically have been located outdoors either above ground or below ground and thus have been protected by a sealed enclosure. When a network protector is approached for maintenance, testing, or repair, the network protector must be electrically and physically disconnected from the power distribution equipment on both the network transformer side and the secondary network side.

Historically, a three-pole knife blade type switch (e.g., a “Pringle Switch”) has been used to disconnect a network protector from an energized network. Additionally, for utilities which do not use a three-pole knife blade type switch, network side fuses have been removed to isolate the network protector from the energized network. However, due to the high currents which pass through the network protector, it is desirable that a technician can easily verify whether a network protector is isolated from an energized network and can easily disconnect and isolate a network protector from the energized network.

### SUMMARY

The disclosed concept provides an electrical disconnect apparatus which can be employed to efficiently and safely remove a fuse to isolate a network protector from an electrical network.

The disclosed concept provides an electrical disconnect apparatus comprising: a housing including a first conductor configured to electrically connect to a first external circuit and a second conductor configured to electrically connect to a second external circuit; and a connection device having an elongated portion structured to be inserted into and removed from the housing. The elongated portion of the connection device includes a fuse having a first conductive end portion and a second conductive end portion electrically connected by a fusible element. The fuse electrically connects the first conductor to the second conductor when the elongated portion of the connection device is inserted into the housing and electrically disconnects the first conductor from the second conductor when the elongated portion of the connection device is removed from the housing.

### BRIEF DESCRIPTION OF THE DRAWINGS

A full understanding of the disclosed concept can be gained from the following description of the preferred embodiments when read in conjunction with the accompanying drawings in which:

FIG. 1 is an isometric view of an electrical disconnect apparatus in accordance with embodiments of the disclosed concept.

FIG. 2 is an exploded isometric view of the electrical disconnect apparatus of FIG. 1.

FIG. 2A is an enlarged view of the indicated portion of FIG. 2.

FIG. 3 is a sectional view as taken along line 3-3 of FIG. 1.

FIG. 4 is a view similar to FIG. 3, except depicting a connection device of the electrical disconnect apparatus partially removed from a housing of the electrical disconnect apparatus.

FIG. 5 is a view of a connection device in accordance with embodiments of the disclosed concept.

FIG. 6 is a view similar to FIG. 5, except that the connection device is rotated.

FIG. 7A is a front view of a lock apparatus in a locked position.

FIG. 7B is a view similar to FIG. 7A, except depicting the lock apparatus in an unlocked position.

FIG. 8A is an end view of the electrical disconnect apparatus of FIG. 1 with the connection device pivoted to a secured configuration.

FIG. 8B is a view similar to FIG. 8A, except depicting the connection device rotated away from the secured configuration.

FIG. 9A is a view of a fuse including a mechanical separation device in accordance with embodiments of the disclosed concept.

FIG. 9B is similar to FIG. 9A, except depicting the fuse after it has blown.

FIG. 10A is an isometric view of a Y fuse link.

FIG. 10B is an isometric view of a Z fuse link.

### DESCRIPTION OF THE PREFERRED EMBODIMENTS

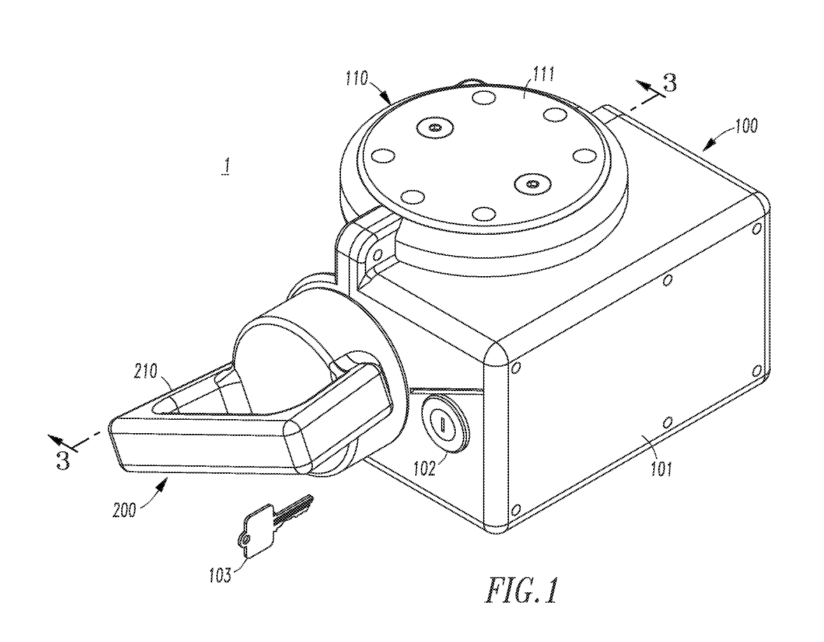

FIGS. 1-4 illustrate an electrical disconnect apparatus 1 in accordance with embodiments of the disclosed concept. The electrical disconnect apparatus 1 includes a housing 100 and a connection device 200.

The connection device 200 includes a handle 210 and an elongated portion 250 having an electrically insulating portion 220 and a fuse 230. The housing 100 and the connection device 200 are structured such that the elongated portion 250 of the connection device 200 can be inserted into and removed from the housing 100.

The housing 100 includes a first conductor 110 and a second conductor 120. The first conductor 110 is configured to electrically connect to a first external circuit (not shown) and the second conductor 120 is configured to electrically connect to a second external circuit (not shown). For example and without limitation, the first external circuit may be an electrical network and the second external circuit may be a network protector. The first conductor 110 includes a first conductive surface 111 which is exposed to the exterior of the housing 100 and the second conductor 120 includes a second conductive surface 121 which is exposed to the exterior of the housing 100. Exposing the first conductive surface 111 and the second conductive surface 121 to the exterior of the housing 100 allows the first conductor 110 and the second conductor 120 to be easily electrically connected to the first external circuit and the second external circuit, respectively.

The first conductor 110 further includes a first receptacle 112 and a first flexible conductor 113 and the second conductor 120 further includes a second receptacle 122 and a second flexible conductor 123. When the elongated portion 250 of the connection device 200 is inserted into the housing 100, the elongated portion 250 of the connection device 200 is received by the first receptacle 112 and the second receptacle 122.

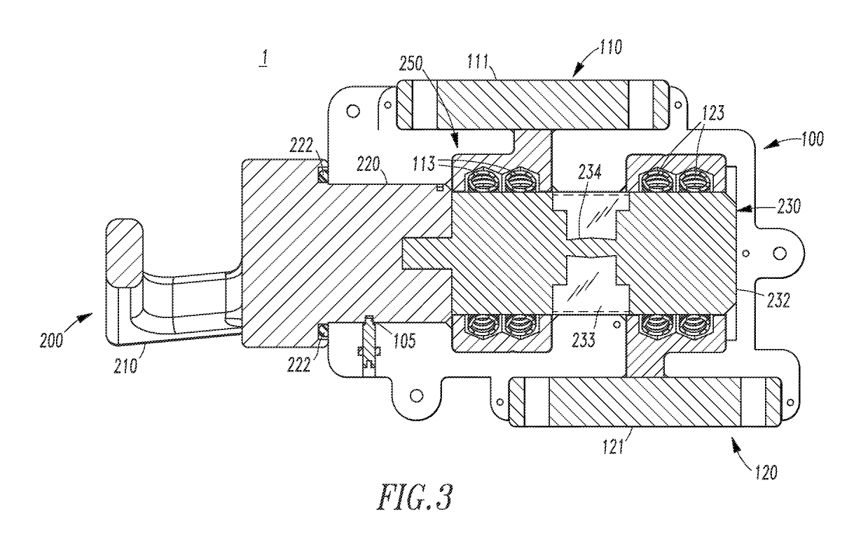

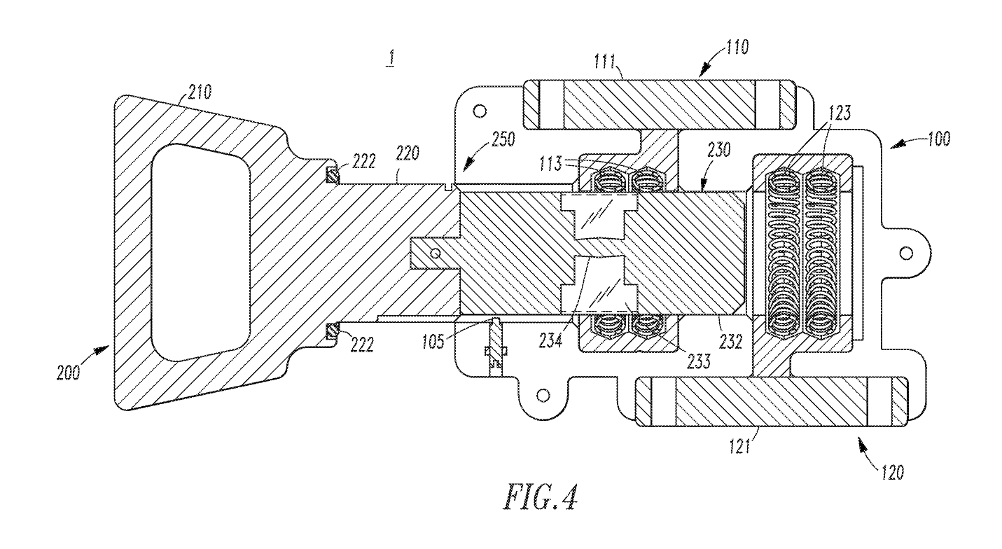

The first flexible conductor 113 is disposed around the first receptacle 112 and similarly, the second flexible conductor 123 is disposed around the second receptacle 122. The first flexible conductor 113 is electrically connected with the first conductive surface 111 and the second flexible conductor 123 is electrically connected with the second conductive surface 121. As can be seen in FIG. 3, when the elongated portion 250 of the connection device 200 is fully inserted into the housing 100, the first flexible conductor 113 and the second flexible conductor 123 contact the fuse 230 so as to electrically connect the first conductor 110 and the second conductor 120, thus creating a conductive path through the fuse 230 between the first conductive surface 111 and the second conductive surface 121. As can be seen in FIG. 4, the elongated portion 250 of the connection device 200 is partially removed from the housing 100 such that the second flexible conductor 123 no longer contacts the fuse 230, thus electrically disconnecting the first conductor 110 from the second conductor 120. Here, when the electrical disconnect apparatus 1 is employed, for example, between a network protector and an electrical network, a technician can easily determine whether the network protector is isolated from the electrical network based on the presence/absence of the connection device 200 in the housing 100. Additionally, the technician can easily electrically connect/disconnect the network protector from the electrical network by inserting/removing the connection device 200.

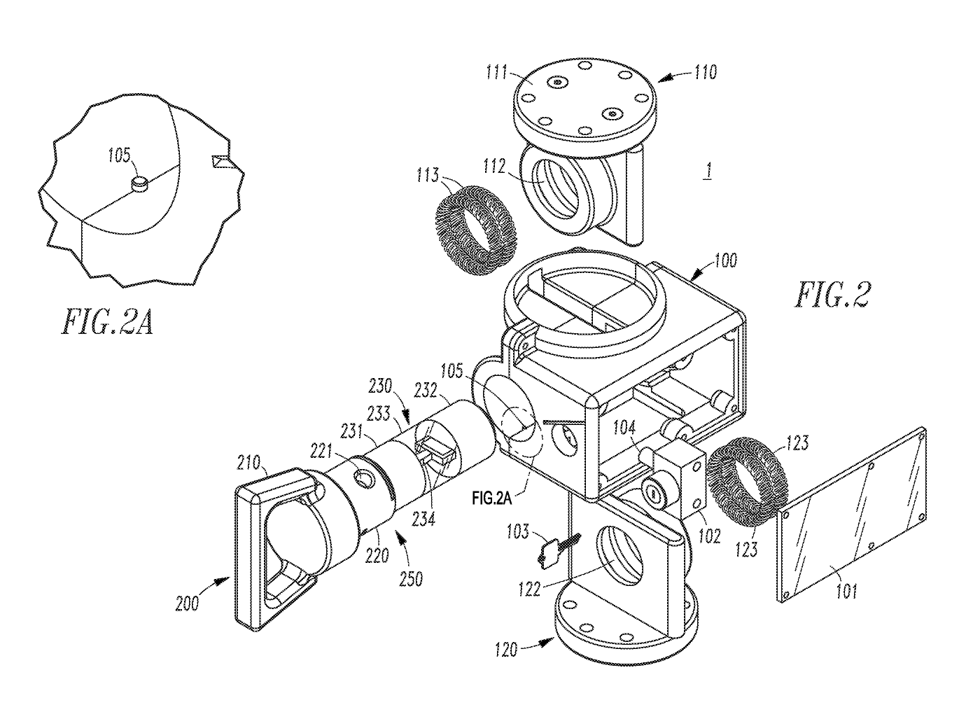

In the example embodiment illustrated in FIGS. 2-4, the first flexible conductor 113 and the second flexible conductor 123 each include two conductive springs. However, it is contemplated that the first flexible conductor 113 and the second flexible conductor 123 may include any number of conductive springs without departing from the scope of the disclosed concept.

In the example embodiment illustrated in FIGS. 2-4, the first receptacle 112 and second receptacle 122 are generally round and the fuse 230 is generally cylindrical. As such, the fuse 230 is easily received by the first receptacle 112 and the second receptacle 122.

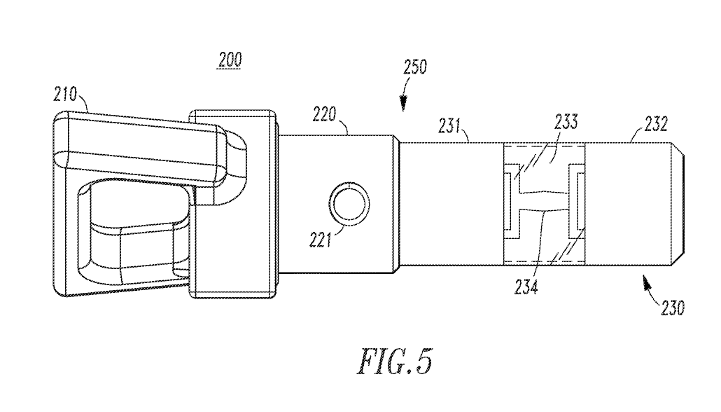

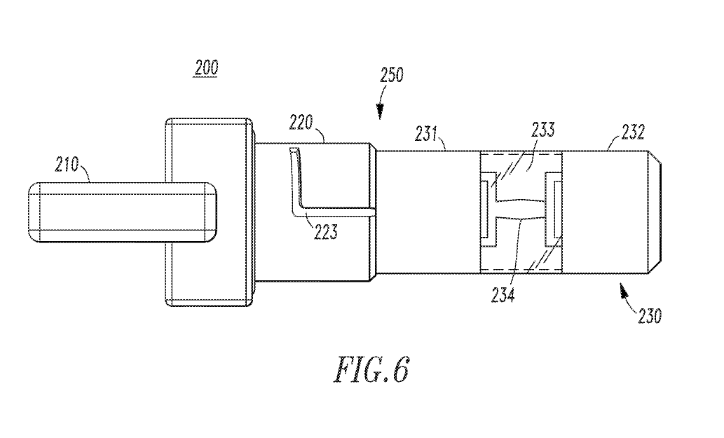

FIGS. 5 and 6 illustrate the connection device 200 independent of the housing 100. The electrically insulating portion 220 of the connection device 200 has a first end to which the handle 210 is attached and an opposite second end to which the fuse 230 is attached. The handle 210 and the fuse 230 may be attached to the electrically insulated portion 220 by any suitable attachment mechanism while remaining within the scope of the disclosed concept. For example and without limitation, the handle 210 may be attached to the electrically insulated portion 220 by molding the handle 210 and the electrically insulated portion 220 together. Also, for example and without limitation, the fuse 230 may be attached to the electrically insulated portion 220 by screwing the fuse 230 and the electrically insulated portion 220 together. When the electrically insulating portion 220 and the fuse 230 are attached by screwing the fuse 230 and the electrically insulating portion 220 together, or in another manner which permits the fuse 230 and the electrically insulating portion 220 to be repeatedly attached and detached, a blown fuse can be replaced without discarding the handle 210 and the electrically insulating portion 220.

The electrically insulated portion 220 electrically insulates the handle 210 from the fuse 230. The handle 210 may be formed of an insulating material or a conductive material.

The fuse 230 includes a first conductive end portion 231 and a second conductive end portion 232 which are electrically connected by a fusible element 234. The first conductive end portion 231 and the second conductive end portion 232 are also coupled by a tube 233. The fuse 230 is structured such that the first conductive end portion 231 contacts the first flexible conductor 113 and the second conductive end portion 232 contacts the second flexible conductor 123 when the elongated portion 250 of the connection device 200 is fully inserted into the housing 100, thus electrically connecting the first conductor 110 with the second conductor 120.

The tube 233 couples the first conductive end portion 231 with the second conductive end portion 232 and surrounds the fusible element 234. The tube may be structured to withstand expulsion characteristics of the fuse 230 blowing, such as, for example, the expulsion of molten material. The tube 233 may be formed of a clear resin which is structured to withstand the expulsion characteristics of the fuse 230. Additionally, the tube 233 may be formed of the clear resin, or other translucent materials, thus permitting the status of the fusible element 234 to be viewed from the exterior of the fuse 230. Furthermore, the area of the fuse 230 around the fusible element 234 may be filled with a gel, such as, for example and without limitation, a clear or translucent gel which permits the status of the fusible element 234 to be viewed from the exterior of the fuse 230 and also enhances the arc suppression and expulsion reduction of the fuse 230.

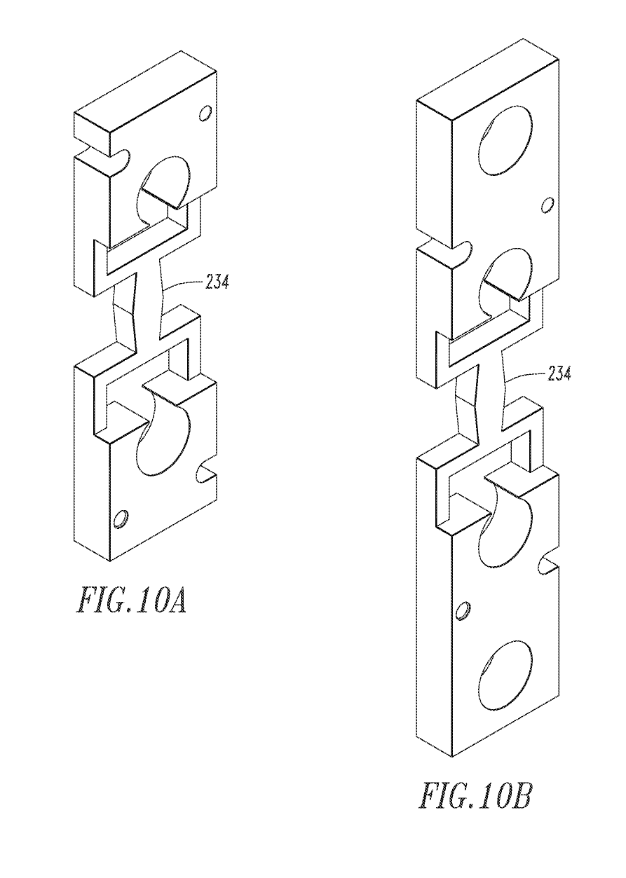

In some embodiments of the disclosed concept, the fusible element 234 is a copper fusible element. Also, in some embodiments of the disclosed concept, the fuse 230 includes a Y fuse link or a Z fuse link. FIG. 10A illustrates an example of a Y fuse link and FIG. 10B illustrates an example of a Z fuse link. Copper Y and Z fuse links are generally designed to handle relatively high currents (e.g, without limitation, about 800 A to about 6 kVA) and low voltage (e.g., without limitation, up to about 600 VAC_{RMS}).

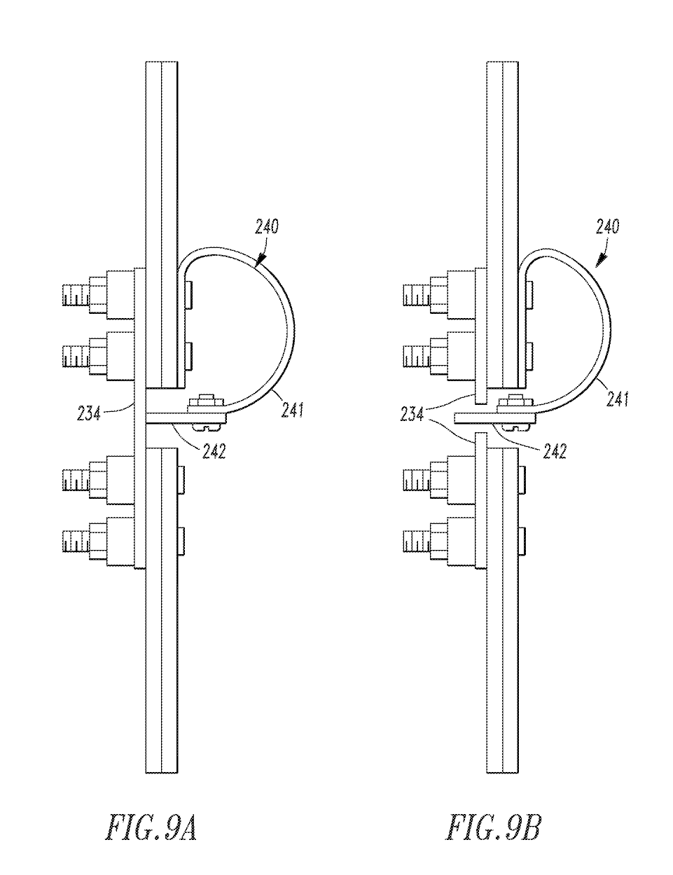

In some embodiments of the disclosed concept, the fuse 230 may include a mechanical separation device 240. FIGS. 9A and 9B illustrate an example embodiment of a mechanical separation device 240 which may be readily adapted for use in the electrical disconnect apparatus 1 shown in FIGS. 1-4. The mechanical separation device 240 includes an elastic member 241 and an insulating barrier 242. The elastic member 241 biases the insulating barrier 242 against the fusible element 234. When the fuse 230 enters an interrupted state and the fusible element 234 melts, the elastic member 241 drives the insulating barrier 242 between melted ends of the fusible element 234, as shown in FIG. 9B. The insulating member 242 is formed of an insulating material such as, for example, fiber reinforced plastic resin, resin coated fabric, vulcanized fabric, fiber reinforced polyester laminate or any other suitable insulating material. The insulating barrier 242 is adapted to prevent an arc from passing between melted ends of the fusible element 234 as the fuse 230 transitions from a non-interrupted state to the interrupted state.

The housing 100 may include a clear or translucent portion 101 disposed on the housing 100 such that the fuse 230 is visible from outside the housing 100. As illustrated in FIG. 1, the translucent or clear portion 101 of the housing 100 forms a side surface of the housing 100. However, it is contemplated that the translucent or clear portion 101 of the housing 100 may be disposed at any suitable location on the housing 100 which allows the fuse 230 to be viewed from the exterior of the housing 100 through the translucent or clear portion 101. In some embodiments of the disclosed concept, the housing 100 includes a clear or transparent portion 101 and the tube 233 of the fuse 230 also includes a clear or transparent portion, thus allowing the status of the fusible element 234 to be viewed from the exterior of the housing 100.

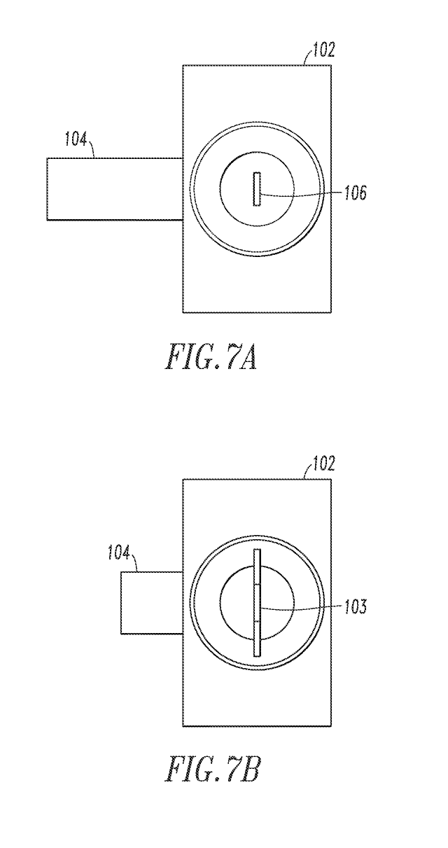

The housing 100 may include a locking part 102. The locking part 102 is depicted generally in FIGS. 1, 2, 7 and 8. The locking part 102 includes a protruding member 104 which is moveable between a locking position as illustrated in FIG. 7A and an unlocking position as illustrated in FIG. 7B. In the locking position, the protruding member 104 interacts with the elongated portion 250 of the connection device 200 to prevent the elongated portion 250 of the connection device 200 from being removed from the housing 100. For example and without limitation, the protruding member 104 may interact with a hole 221 formed in the connection device 200 to secure the connection device 200 in place.

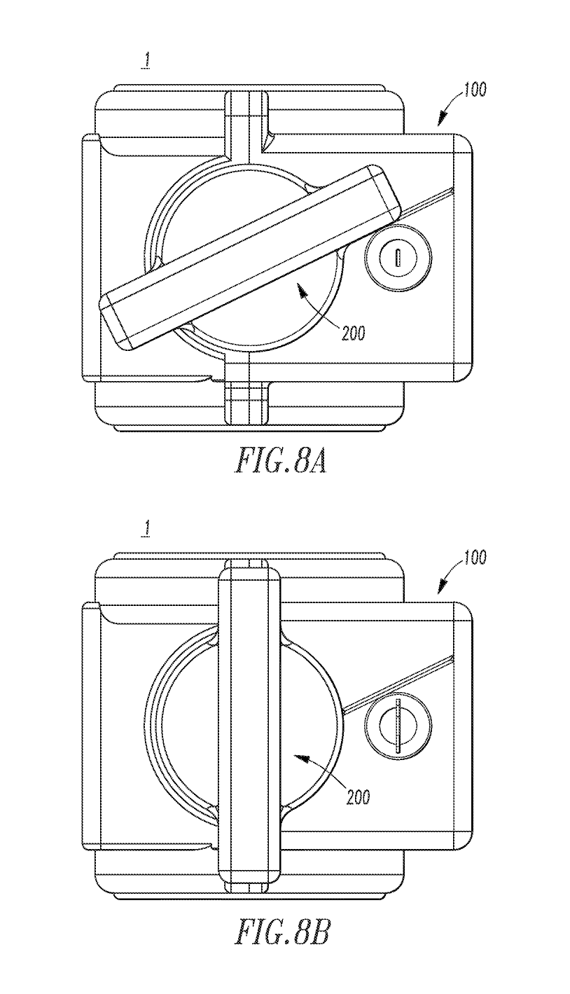

The connection device 200 may be rotated to a predetermined position to align the hole 221 of the connection device 200 with the protruding member 104 of the locking part 102. The housing 100 may include a marking (e.g., the word “LOCKED”) indicating the predetermined position, as illustrated in FIG. 8A, to allow visual confirmation as to whether the connection device is in the locked position (FIG. 8A) or in an unlocked position (FIG. 8B).

The locking part 102 may be locked and unlocked by inserting a key 103 into a key hole 106 and rotating the key 103. However, it is contemplated that any suitable manner of locking and unlocking the locking part 102 may be employed without departing from the scope of the disclosed concept.

The housing 100 may include a protrusion 105, as illustrated in FIGS. 2 and 2A, and the connection device 200 may include a groove 223, as illustrated in FIG. 6, configured to interact with the protrusion 105. The protrusion 105 and the groove 223 interact to restrict rotation of the connection device 200 when the connection device 200 is being inserted into the housing 100. The example groove 223 illustrated in FIG. 6 prevents rotation of the connection device 200 until the elongated portion 250 of the connection device 200 is sufficiently inserted into the housing 100, and then permits the connection device 200 to be rotated a limited amount. It is contemplated that various suitable configurations of grooves may be employed without departing from the scope of the disclosed concept. It is also contemplated that the groove 223 and the protrusion 105 may be switched such that a protrusion is formed on the connection device 200 and a groove is formed in the housing 100 without departing from the scope of the disclosed concept.

The connection device 200 may also include a sealing element 222. The sealing element 222 may be disposed on the connection device 200 such that when the elongated portion 250 of the connection device 200 is inserted into the housing 100, the sealing element 222 contacts the housing 100 to seal the interface between the connection device 200 and the housing 100, as illustrated for example in FIG. 3, thus preventing fluid from reaching the interior of the housing 100 when the electrical disconnect apparatus 1 is employed in submerged conditions. It is contemplated that a sealing element may be disposed on the housing 100 in addition to or in place of the sealing element 222 on the connection device 200 without departing from the scope of the disclosed concept.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. An electrical disconnect apparatus comprising:
a housing including a first conductor configured to electrically connect to a first external circuit and a second conductor configured to electrically connect to a second external circuit; and
a connection device having an elongated portion structured to be inserted into and removed from the housing,
wherein the elongated portion of the connection device includes a fuse having a first conductive end portion and a second conductive end portion electrically connected by a fusible element ; and
wherein the fuse electrically connects the first conductor to the second conductor when the elongated portion of the connection device is inserted into the housing and electrically disconnects the first conductor from the second conductor when the elongated portion of the connection device is removed from the housing.

2. The electrical disconnect apparatus of claim 1, wherein the first conductor includes a first receptacle and the second conductor includes a second receptacle; and wherein the elongated portion of the connection device is configured to be inserted into the first receptacle and the second receptacle .

3. The electrical disconnect apparatus of claim 2, wherein the first conductor includes a first flexible conductor disposed around the first receptacle and the second conductor includes a second flexible conductor disposed around the second receptacle; and wherein when the elongated portion of the connection device is inserted into the housing, the first flexible conductor contacts the first conductive end portion of the fuse and the second flexible conductor contacts the second conductive end portion of the fuse to electrically connect the first conductor and the second conductor.

4. The electrical disconnect apparatus of claim 2, wherein the first receptacle and the second receptacle are round and the fuse is cylindrical.

5. The electrical disconnect apparatus of claim 1, wherein the connection device includes a handle and the elongated portion; wherein the elongated portion includes the fuse and an electrically insulated portion having a first end and an opposite second end; and wherein the fuse is coupled to the first end of the electrically insulated portion and the handle is coupled to the opposite second end of the electrically insulated portion.

6. The electrical disconnect apparatus of claim 1, wherein the fuse includes one of a Y fuse link and a Z fuse link.

7. The electrical disconnect apparatus of claim 1, wherein the fusible element is a copper fusible element.

8. The electrical disconnect apparatus of claim 1, wherein the fuse comprises a mechanical separation device.

9. The electrical disconnect apparatus of claim 8, wherein the mechanical separation device includes an elastic member and an insulating barrier coupled to the elastic member; and wherein when the fusible element of the fuse melts, the elastic member drives the insulating barrier between ends of the melted fusible element.

10. The electrical disconnect apparatus of claim 1, wherein the fuse comprises a tube coupled between the first conductive end portion and the second conductive end portion; and wherein the tube is made of an insulating material structured to contain expulsion characteristics of the fuse.

11. The electrical disconnect apparatus of claim 10, wherein the tube includes a translucent or clear portion disposed such that the fusible element is visible through the translucent or clear portion of the tube.

12. The electrical disconnect apparatus of claim 11, wherein the tube is made of a clear resin.

13. The electrical disconnect apparatus of claim 1, wherein the housing includes a translucent or clear portion disposed such that when the elongated portion of the connection device is inserted into the housing, the fuse is visible through the translucent or clear portion of the housing.

14. The electrical disconnect apparatus of claim 1, wherein the housing includes a locking part having a protruding member moveable between a locked position and an unlocked position; wherein when the elongated portion of the connection device is inserted into the housing and the protruding member is in the locked position, the protruding member interacts with the elongated portion of the connection device to prevent the elongated portion of the connection device from being removed from the housing; and wherein when the protruding member is in the unlocked position, the protruding member allows the elongated portion of the connection device to be removed from the housing.

15. The electrical disconnect apparatus of claim 1, wherein at least one of the connection device and the housing comprises a seal element which, when the elongated portion of the connection device is inserted into the housing, seals an interface between the housing and the connection device.

16. The electrical disconnect apparatus of claim 1, wherein one of the housing and the elongated portion of the connection device includes a protrusion and the other of the housing and the elongated portion of the connection device includes a groove; and wherein an interaction between the protrusion and the groove restricts rotation of the elongated portion of the connection device while the elongated portion of the connection device is being inserted into the housing.
